(19) United States
(12) Patent Application Publication
(10) Pub. No.: US 2014/0197159 A1
(43) Pub. Date: Jul. 17, 2014

(54) MAGNETIC FIELD FOR SINTERING CONDUCTIVE MATERIAL WITH NANOPARTICLES

(71) Applicant: Xenon Corporation, Wilmington, MA (US)

(72) Inventors: C. Richard PANICO, Medford, MA (US); Louis R. PANICO, Danvers, MA (US)

(21) Appl. No.: 14/156,205

(22) Filed: Jan. 15, 2014

Related U.S. Application Data
(60) Provisional application No. 61/752,809, filed on Jan. 15, 2013.
(60) Provisional application No. 61/760,845, filed on Feb. 5, 2013.

(51) Int. Cl. H05B 6/02

(52) U.S. Cl. CPC H05B 6/02
USPC 219/635

(57) ABSTRACT

Conductive particle sintering systems including a conveyor for conveying a low-temperature substrate with a conductive ink having metallic nanomaterial on the substrate, the conveyor for conveying the substrate along a first direction; and at least one source of alternating magnetic field configured to provide sufficient energy to the conductive ink to cause the nanomaterial in the ink to be sintered; such that the at least one source of magnetic field is positioned above and/or below the substrate and oriented in a second direction substantially perpendicular to the first direction. Also disclosed are methods using such sintering systems.

### CROSS-REFERENCE TO RELATED APPLICATIONS

This application claims priority from Provisional Application Ser. No. 61/752,809, filed Jan. 15, 2013, and Provisional Application Ser. No. 61/760,845, filed Feb. 5, 2013, the entireties of which are incorporated herein by reference.

### BACKGROUND

This disclosure relates to systems and methods for sintering, and particularly, sintering metal nanoparticles and/or microparticles.

In processing a material with fine particles, sintering is a process whereby metal particles are heated and made to cohere to one another, forming a continuous metallic film. Sintering systems and methods can require high temperatures. In the case of sintering a metal on a substrate, high temperature can damage the substrate. Nanotechnology has made possible the sintering of metallic inks, formed on substrates, at lower temperatures than would be required with larger particles. While a metal has a specific melting temperature, a nanometal, which is a nanometer-sized particle of a metal, can melt at a lower temperature. A sintering system using pulsed light and/or high intensity continuous light can bind nanometals to one another and onto substrates using lower temperatures than those used with conventional sintering systems.

Sintering has broad applications, such as in the emerging field of printed electronics. Printed electronics includes printing electrically functional devices, including, but not limited to, radio frequency identification (RFID) tags, antennas, touch panels (replacing ITO, etc.), lighting devices, semiconductors, batteries, super capacitors, and solar cells. Printing electronic devices can be less costly and more efficient than conventional methods for producing such devices.

Conductive inks, such as those including nanometals, can be sintered with radiant energy that can include combinations of pulsed light, high intensity continuous light, ultraviolet light, radiation, and thermal energy. A UV flash lamp, for example, can be used. It provides UV radiation and thermal energy (and also includes energy in the visible range and infrared range). When the particles are sintered, they form a continuous conductive path that has a conductivity that is much higher than the particles have pre-sintering. The electronically functional devices could be fabricated by sintering single layer or multiple layers.

### BRIEF DESCRIPTION OF THE DRAWINGS

The features and advantages of certain embodiments are illustrated in the accompanying drawings.

FIG. 1 is a schematic illustration of embodiments of the disclosed systems and methods of sintering using an alternating magnetic field source positioned above a substrate on a conveyor system.

FIG. 2 is a schematic illustration of embodiments of the disclosed systems and methods of sintering using an alternating magnetic field source positioned below a substrate on a conveyor system.

FIG. 3 is a schematic illustration of embodiments of the disclosed systems and methods using more than one magnetic field source.

### DETAILED DESCRIPTION

The present disclosure relates to systems and methods for sintering using an alternating magnetic field, rather than a laser or lamp (or possibly in conjunction with a laser or lamp). The alternating magnetic field heats and sinters small particles in a conductive ink or other material printed or deposited on a low temperature substrate in a conveyor system. The small particles include nanoparticles and microparticles. Induction heating is a method of heating an electrically conducting material, for example, a metal, by electromagnetic induction. Induction heating occurs through eddy currents or hysteresis. Eddy currents are electric currents that are induced by a changing magnetic field in any conductor, and hysteresis can occur in any magnetic material. For metals, such as iron and some types of steel, induction heating can also occur through hysteresis loss. The alternative magnetic field in an induction coil rapidly flips the magnetic domains, which causes friction and heating inside the material, and this mechanisms is known as hysteresis loss.

Various frequencies of the alternating current are contemplated. The frequency depends on a variety of factors, including the type of material on the substrate and coupling interactions between the magnetic field source and the material to be heated. In some embodiments, the systems and methods provide two or more sources of alternating magnetic field, and the ink is exposed to the same or different frequencies from the two or more magnetic field sources.

A low temperature substrate can include, but is not limited to, substrates such as paper and polymer substrates such as polyester, polyethylene terephthalate (PET), poly(diallyldimethylammonium chloride (PDAA), polyacrylic acid (PAA), poly (allylamine hydrochloride) (PAH), poly(4-styrenesulfonic acid), poly(vinyl sulfate) potassium salt, 4-styrenesulfonic acid sodium salt hydrate, polystyrene sulfonate (PSS), polyethylene imine (PEI), polyethylene, or some other thin film or sheet, including those identified in U.S. application Ser. No. 13/586,125, filed Aug. 19, 2012, which is incorporated herein in its entirety.

Methods of sintering include moving a workpiece along a first direction a low-temperature substrate having a conductive ink including small metallic particles, micromaterial or nanomaterial, formed on the low-temperature substrate. Energy is provided from one or more sources of alternating magnetic field to the conductive ink, and the energy is provided in a second direction that is substantially perpendicular to the first direction. In the disclosed methods, the energy sinters the metallic nanomaterial such that the conductivity of the nanomaterial increases relative to the conductivity of the conductive ink before sintering. In some embodiments, the conductivity of the nanomaterial increases by orders of magnitude relative to the conductivity of the conductive ink before sintering.

Because the substrate is made of a non-metallic material, the induction heating can specifically heat the metallic portions of the material without over-heating the substrate. In some embodiments, an alternating magnetic field is not only used for sintering, but also for drying the conductive ink.

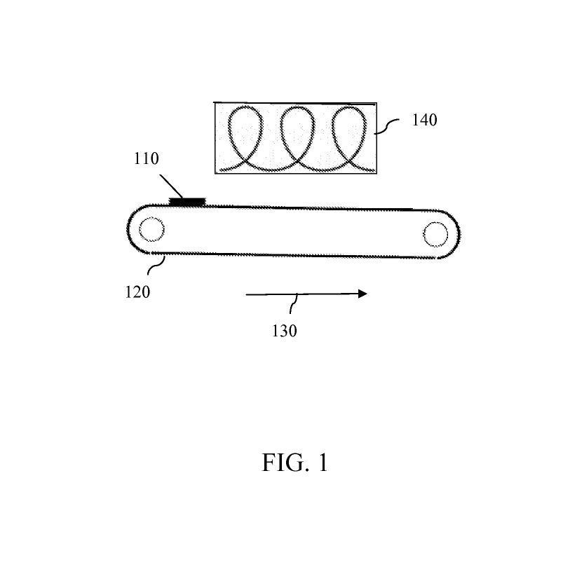

FIG. 1 is a schematic illustration of a system and method showing one or more embodiments of the instant disclosure. FIG. 1 shows that an alternating magnetic field generates energy that sinters a nanomaterial such that it becomes conductive. In one embodiment, the conveyor operates at about 2.5 ft/min (or 0.8 m/min). The workpiece 110 represents a conductive ink having metallic nanomaterial on a low-temperature substrate. The material to be sintered can be provided onto the substrate using one or more technologies well known in the art, including screen-printing, inkjet printing, gravure, laser printing, inkjet printing, xerography, pad printing, painting, dip-pen, syringe, airbrush, flexography, evaporation, sputtering, etc.

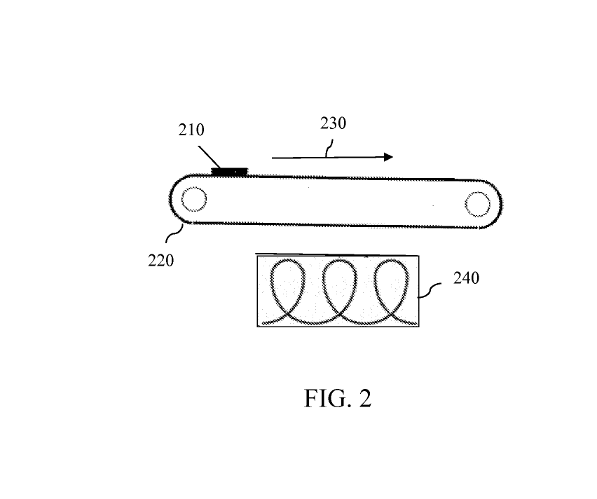

FIGS. 1 and 2 are conceptual figures showing a workpiece 110 placed on a conveyor system 120, which conveys the substrate along a first direction 130. During sintering, the workpiece is subjected to energy generated by the alternating magnetic field source 140. In some embodiments, the source of alternating magnetic field is configured to provide sufficient energy to cause the nanomaterial in the ink to be sintered. In some embodiments, the strength of the alternating magnetic field is not so high as to cause partial sintering to occur. As shown in FIG. 1, the source of alternating magnetic field is positioned above the substrate and oriented to provide energy in a second direction that is substantially perpendicular to the first direction 130. The energy irradiates the advancing substrate such that full sintering occurs. In some embodiments, the conveyor is configured to convey the substrate along the first direction 130, as well as along a direction along the same axis that is opposite to the first direction 130. In some embodiments, the conveyor is configured to convey the substrate back-and-forth once or multiple times along the first direction 130 and along the same axis that is the opposite of the first direction 130. While represented schematically as a coil, multiple coils or other sources could be used, for example, arranged in a one-dimensional or two-dimensional array.

In FIG. 2, the workpiece 210 can also include a conductive ink having metallic nanomaterial on a low-temperature substrate. Workpiece 210 is placed on conveyor system 220, which conveys the substrate along a first direction 230. During sintering, the workpiece is subjected to energy generated by the source of alternating magnetic field 240. In some embodiments, the source of magnetic field is configured to provide sufficient energy to cause the nanomaterial in the ink to be sintered. As shown in FIG. 2, the source of alternating magnetic field is positioned below the substrate and oriented to provide energy in a second direction that is substantially perpendicular to the first direction 130. The direction in which the alternating magnetic field generates energy can be determined based on the conditions and positions of the various workpieces, including the substrate. The energy irradiates the advancing substrate such that full sintering occurs. While shown under both “bands” of the conveyor, the magnetic energy source can be just under the top of the conveyor.

In some embodiments, the disclosed systems and methods include an additional source of heat. In one embodiment, one or more plates are provided to receive energy from the at least one magnetic field source. One or more plates made of magnetic metal can be located above, below, or both above and below the substrate. A plate receiver made of magnetic metal can be used under the substrate where the magnetic field source is overhead, and vice versa. In some embodiments, the energy generated by the alternating magnetic field passes through the ink to a plate on the other side of the substrate, and the heat generated by the plate helps to fully sinter the nanomaterial in the ink. The heat generated by the plate can enhance sintering, but would be provided without over-heating the substrate. Thus, the source of magnetic energy can provide both induction heating and radiation heating at the same time.

A number of different non-magnetic or magnetic particles can be used in the conductive material, such as silver, copper, aluminum, iron, gold, palladium, tin, tungsten, titanium, chromium, vanadium, aluminum, and alloys and mixtures thereof.

As noted above, the sintering systems include a conveyor system with the substrate positioned directly above the conveyor. The conveyor can operate at various speeds to move the substrate. A conveyor control module can determine the speed at which the substrate is being moved. For example, the conveyor system can operate in a start/stop motion as well as in a continuous motion. The motion of the conveyor is coordinated with energy generated by the at least one source of magnetic field to ensure that the workpiece gets a sufficient amount of energy for sintering where needed. The workpiece can include larger pieces, such that the energy can be provided to a portion at one time, and then is provided to another portion. Or, there can be a succession of different pieces, e.g., on a conveyor.

In some embodiments, the conveyor system can use a stop-and-go process or a continuous running process, e.g., where material comes from a roll and is provided to another roll after processing, or coming from a printing line to the sintering station and then to a roll. In some embodiments, a roll-to-roll process is used where a sheet of nanomaterial is sintered. Provisional Application No. 61/681,984, filed Aug. 10, 2012 provides methods for implementing a continuous process, and is incorporated herein in its entirety. In one embodiment, rather than using a separate station, the source of alternating magnetic field is located close to the output of an inkjet printer or other source of ink printing to sinter the ink soon after it is deposited on a plastic film or other substrate. As with the other embodiment, a magnetic field source, such as an induction coil, is driven by an alternating current by a control unit that can also get feedback from sensors indicating speed of the process or indicating the success of the sintering. An induction coil carries high-frequency alternating current.

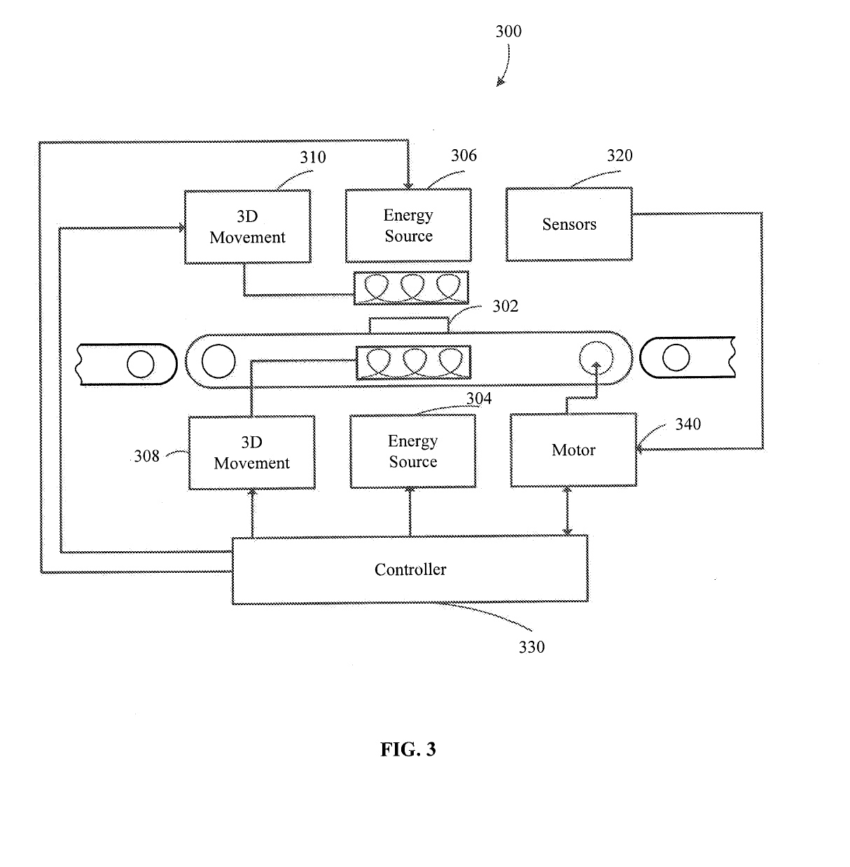

Referring to FIG. 3, in the disclosed conveyor system 300, a substrate 302 can be provided “roll-to-roll,” in that a substrate is introduced on a roll (not shown), passes through a station in which nanoparticles are patterned at desired portions on the surface, sintering is provided to form conductive traces, and the substrate is taken up on a roll for further use. The substrate could be provided on a roll on the input side, and on the output side. Rather than being provided to a new roll, the finished product could be cut to create individual pieces. In another embodiment, the substrate could be scored in such a manner that it is taken up on a roll, but is partially cut or otherwise processed to make it easier to create separate substrates at a later point in time.

The conveyor system can include energy sources for energizing the coils or other sources of magnetic energy 304, 306; 3D movement systems 308, 310 to allow the sources 304 and 306, respectively, to be moved relative to the moving workpiece along three coordinate axes including parallel to the conveyor's direction of movement, parallel to the direction of energy, and perpendicular to both the direction of movement and the direction of energy; and sensors 320 that can include speed sensors, e.g., a tachometer, to monitor the actual speed of the conveyor, in case it deviates from the expected speed, and other sensors that detect whether the sintering is being done sufficiently well and for sensing the location of the workpiece. The system can include measurement systems, such as optical detection or metering to determine if suitable energy is provided and/or that suitable results are obtained, and the controller can respond accordingly to the information fed back from the measurement systems. Energy sources 304 and 306 can be substantially identical and operated in a substantially identical manner, or they can be different and/or operated in a different manner, e.g., in terms of timing, amplitude, and/or frequency. The movement is represented as 3D, but could be limited to one or two dimensional, e.g., in a direction to move the source closer or further from the workpiece, or to move the source laterally with respect to the direction of the conveyor.

A controller 330 can be coupled to conveyor motor 340; sensors 320; energy sources 304, 306; and 3D movement systems 308 and 310 to receive inputs and to control operation of the system, including to turn on and off the source depending on the position, to monitor an adjust conveyor speed, to increase or decrease energy, etc. Calibration and/or test regions can be provided on the conveyor and/or on the target material and read visually or in an automated manner to determine that the desired energy is being provided at the desired locations. If read in an automated manner, the data can be fed back to controller 330 to make adjustments. The controller of control system can use any appropriate form of processing, including microcontroller, microprocessor, ASIC, special purpose processor, general purpose computer, group of computers, etc.

In various embodiments, the source(s) of the magnetic field can be mounted above, below, or both above and below the substrate and conductive ink at different positions relative to the conveyor system, and there can be one or multiple stations of magnetic sources, each with sources of magnetic field mounted above, below, or both above and below the conveyor.

The systems and methods disclosed herein can be used alone or in conjunction with other suitable methods discussed herein. Various suitable sources of alternating magnetic fields are contemplated, including a coil of wire with a controllable variable current area treatment. In some embodiments, a magnetic flux concentrator is used for point and small area sintering. A magnetic flux concentrator can provide selective heating of certain areas of the material to be sintered; improve the electrical efficiency of the conduction coil; and/or act as a shield to reduce or prevent undesirable heating of adjacent regions on a workpiece. A magnetic flux concentrator can form a magnetic path to channel the coil's magnetic flux in an area outside the coil.

In the disclosed systems and methods, the magnetic field source provides an alternating current. In some embodiments, the alternating current can be provided in a continuous manner, or it can be a start/stop mode with on times ranging from less than one second to greater than 1 second. The current can also be delivered in a high energy “pulsed” mode as a single pulse or start-stop pulse mode, or a continuous train of pulses, e.g., in a pulsing manner where the energy is provided for about 1-50 milliseconds and then off for 1-50 milliseconds. The alternating current and/or pulsed mode can be used in conjunction with heat from direct heat source or infrared light.

The methods and apparatus also include testing and monitoring functions such that the methods include testing can include applying energy to a printed ink on a substrate, and testing to determine whether the ink is sufficiently sintered. At another time, the substrate with a coating and a printed ink is sintered, and then tested to determine that the sintering was sufficient to increase conductivity of the ink. The methods and apparatus can also include ongoing monitoring to ensure that the sintering is effective.

A variety of energy levels are contemplated. These ranges depend on a variety of factors, including the type of nanoparticle to be sintered and other sintering conditions. Sintering energy levels are selected such that partial sintering does not occur, and such that the nanoparticles and substrates are not damaged during sintering. In some embodiments, sintering removes initial impurities in the conductive ink, as described in U.S. application Ser. No. 13/586,125, filed Aug. 15, 2012, which is incorporated herein in its entirety.

Having described embodiments, it should be apparent that modifications can be made without departing from the scope of the inventions described herein. For example, the system can be used in conjunction with other materials not specified.

What is claimed is:

1. A sintering system, comprising:
a conveyor for conveying a low-temperature non-metallic substrate with a conductive ink having small metallic particles on the substrate, the conveyor for conveying the substrate along a first direction; and
at least one source of alternating magnetic field configured to provide sufficient energy to the conductive ink to cause the nanomaterial in the ink to be sintered;
wherein the at least one source of alternating magnetic field is positioned above and/or below the substrate and oriented to provide energy in a second direction substantially perpendicular to the first direction.

2. The sintering system of claim 1, further comprising a magnetic flux concentrator for concentrating energy from at least one of the sources of alternating magnetic field.

3. The sintering system of claim 1, wherein the at least one source of alternating magnetic field includes an induction coil.

4. The sintering system of claim 1, wherein the conveyor includes a stop-and-go system or a continuous running system.

5. The sintering system of claim 1, wherein the magnetic field is delivered as one or more pulses.

6. The sintering system of claim 1, wherein one magnetic field source is oriented in a first position above or below the substrate, and another magnetic field source is oriented in a second position downstream that is the opposite of the first position relative to the substrate.

7. The sintering system of claim 1, wherein the conveyor is configured to convey the substrate along the first direction and along a direction along the same axis that is opposite to the first direction.

8. The sintering system of claim 1, wherein the two or more sources of alternating magnetic field is configured to provide the same or different frequencies.

9. The sintering system of claim 1, further comprising a controller for controlling the speed of the conveyor.

10. The sintering system of claim 1, further comprising a controller for controlling the energy provided by the one or more sources in response to sensor information.

11. The sintering system of claim 1, wherein the source of magnetic energy is movable along a direction lateral to the first direction and/or perpendicular to the plane of the conveyor.

12. The sintering system of claim 1, further comprising a source of radiant heating that is energized by the source of magnetic energy.

13. A method of sintering comprising:
moving along a first direction a workpiece having low-temperature non-metallic substrate and a conductive ink, including small metallic particles, formed on the substrate; and
providing energy from one or more sources of alternating magnetic field to the conductive ink, wherein the energy is provided in a second direction that is substantially perpendicular to the first direction,
wherein the energy sinters the metallic particles such that the conductivity of the ink increases relative to the conductivity of the conductive ink before sintering.

14. The method of claim 13, further comprising concentrating the energy from one or more sources of alternative magnetic field using a magnetic flux concentrator.

15. The method of claim 13, further comprising controlling the amount of energy based on the output of a sensor.

16. The method of claim 13, comprising moving in a stop-and-go manner or in a continuous manner.

17. The method of claim 13, comprising delivering the magnetic field as one or more pulses.

18. The method of claim 13, wherein the low-temperature substrate is moved along a first direction and/or along a direction along the same axis that is opposite to the first direction.

19. The method of claim 13, comprising providing energy from at least two sources of alternating magnetic field with different frequencies.
